(19) United States
(12) Patent Application Publication
(10) Pub. No.: US 2011/0043920 A1
(43) Pub. Date: Feb. 24, 2011

(54) OPTICAL SHEET WITH HIGH CONTRAST RATIO AND FILTER COMPRISING THE SAME, AND IMAGE DISPLAYING DEVICE INCLUDING THE SHEET OR THE FILTER

(75) Inventors: Jong-Pil Chun, Daejeon-City (KR); Bu-Seup Song, Daejeon-City (KR); Ki-Cheol Yoon, Cheonan-city (KR); Woo-Ju Jeong, Daejeon-City (KR); Seong-Joong Kim, Seongnam-City (KR)

Correspondence Address: Nixon Peabody LLP, P.O. Box 60610, Palo Alto, CA, 94306, US

(73) Assignee: SAMSUNG FINE CHEMICALS CO., LTD., Ulsan-city (KR)

(21) Appl. No.: 12/668,411

(22) PCT Filed: Jul. 8, 2008
(86) PCT No.: PCT/KR2008/004010

§ 371 Date: Jan. 8, 2010

(30) Foreign Application Priority Data
Jul. 11, 2007 (KR) 10-2007-0069808

(51) Int. Cl. G02B 5/22

(52) U.S. Cl. 359/614

(57) ABSTRACT

An optical sheet for enhancing contrast ratio, a filter including the same, and an image display device including the optical sheet or the filter. The optical sheet includes: a light transmission portion including a plurality of grooves disposed at predetermined intervals in an end portion of the light transmission portion on one side; and a plurality of external light absorption portions each disposed in said each groove and comprising a composition completely or incompletely filling the groove, the composition comprising a light absorbable material, wherein at least one of the grooves comprises a recess portion formed on the top of the external light absorption portion. When used in the image display device, the optical sheet and the filter including the optical sheet can achieve a relatively high light transmission rate, prevent formation of ghost images, prevent the occurrence of the Moire phenomenon, and achieve a relatively high contrast ratio to maintain high resolution.

### CROSS-REFERENCE TO RELATED PATENT APPLICATION

This application is a national phase International Application No. PCT/KR2008/004010, entitled, “Optical Sheet With High Contrast Ratio And Filter Comprising The Same, and Image Displaying Device Including The Sheet Or The Filter”, which was filed on Jul. 8, 2008, and which claims priority of Korean Patent Application No. 10-2007-0069808 filed Jul. 11, 2007, in the Korean Intellectual Property Office, the contents of which are incorporated herein by reference.

### BACKGROUND OF THE INVENTION

1. Field of the Invention

The present invention relates to an optical sheet for enhancing a contrast ratio, a filter including the same, and an image display device including the optical sheet or the filter, and more particularly, to an optical sheet capable of increasing a light transmission rate, increasing a resolution by preventing a decrease in a contrast ratio of an image due to external light, preventing formation of ghost images, and preventing the Moire phenomenon, a filter including the same, and an image display device including the optical sheet or the filter.

2. Description of the Related Art

Recently, various types of image display devices have been developed and used practically. Examples of image display devices include liquid crystal displays (LCDs), plasma display panels (PDPs), field emission displays (FEDs), cathode ray tubes (CRTs), vacuum fluorescence displays, and field emission display panels. These image display devices realize emission of light of the three primary colors of red, blue, and green, thereby displaying color images.

An image display device includes: a panel assembly that forms images; and a filter that shields electromagnetic waves, near-infrared rays, and/or orange light emitted from the panel assembly, prevents surface reflection, and/or performs color adjustment. The filter should be transmissive because the filter is disposed on a front side of the panel assembly.

The filter, however, absorbs and/or reflects image light emitted from the panel assembly and decreases brightness of the image display device. In addition, in a bright environment, for example, in a bright room, external surrounding light passes through the filter of the image display device and can enter the panel assembly. In this regard, the external surrounding light that passes through the filter from the outside may interfere with the image light emitted from the panel assembly, and thus, the contrast ratio is decreased and image display capability of the image display device is degraded.

To address these problems, an optical sheet may be used. In general, a conventional optical sheet includes wedge-shaped external light absorption portions which include a light absorbable material and are disposed at predetermined intervals in a transparent light transmission portion. However, in addition to absorbing external surrounding light to enhance a contrast ratio of an image, the external light absorption portions can also absorb some of the light emitted from an image light source and decrease a light transmission ratio of image light. Specifically, the external light absorption portions can be formed by filling a light transmission portion with a composition including a light absorbable material using a conventional method such as screen printing or wiping. However, screen printing is expensive because it is difficult to selectively fill grooves formed in light transmission portions with the composition, and wiping may cause a decrease in a light transmission rate because a light absorbable material may remain even on the light transmission portion when filling with the composition.

### SUMMARY OF THE INVENTION

The present invention provides an optical sheet capable of preventing a decrease in an external light absorption rate and improving a light transmission rate.

The present invention also provides an optical sheet capable of enhancing a contrast ratio in a bright room and preventing formation of ghost images.

The present invention also provides an optical sheet that can be manufactured relatively inexpensively and that prevents contamination of a light transmission portion.

The present invention also provides an optical sheet capable of preventing the Moire phenomenon.

The present invention also provides a filter including the optical sheet having characteristics described above.

The present invention also provides an image display device which has high brightness and high resolution and in which the Moire phenomenon does not occur, by having the optical sheet having the characteristics described above or the filter.

According to an aspect of the present invention, there is provided an optical sheet including: a light transmission portion comprising a plurality of grooves disposed at predetermined intervals in an end portion of the light transmission portion on one side; and a plurality of external light absorption portions each disposed in said each groove and comprising a composition completely or incompletely filling said each groove, the composition comprising a light absorbable material, wherein at least one of the grooves comprises a recess portion formed on the top of the external light absorption portion.

According to an embodiment of the present invention, a ratio of a maximum depth of a interface between the recess portion and the light transmission portion to a width of the corresponding external light absorption portion may be in a range of 1/400 to 1/1. Preferably, a width of the external light absorption portion may be in a range of 10 to 40 μm and the maximum depth of the interface between the recess portion and the light transmission portion may be in a range of 0.1 to 10 μm.

According to another embodiment of the present invention, a ratio of a maximum depth of the recess portion to a width of the corresponding external light absorption portion may be in a range of 1/400 to 2/1. Preferably, the width of the external light absorption portion may be in a range of 10 to 40 μm, and the maximum depth of the recess portion may be in a range of 0.1 to 20 μm.

According to another embodiment of the present invention, a ratio of a maximum depth of a interface between the recess portion and the light transmission portion to a depth of the corresponding external light absorption portion may be in a range of 1/2000 to 1/5. Preferably, the depth of the external light absorption portion is in a range of 50 to 200 μm and the maximum depth of the interface between the recess portion and the light transmission portion is in a range of 0.1 to 10 μm.

According to another embodiment of the present invention, a ratio of a maximum depth of the recess portion to a depth of the corresponding external light absorption portion may be in a range of 1/2000 to 2/5. Preferably, the depth of the external light absorption portion may be in a range of 50 to 200 μm, and the maximum depth of the recess portion is in a range of 0.1 to 20 μm.

According to another embodiment of the present invention, an end portion of the light transmission portion on an image light source side that contacts an end portion of the external light absorption portion on the image light source side comprises a convex portion, wherein the convex portion partially defines the recess portion.

According to another embodiment of the present invention, a refractive index of the light transmission portion is less than a refractive index of the external light absorption portions.

According to another embodiment of the present invention, each of the external light absorption portions has a triangular, trapezoidal, or pentagonal-shaped cross section.

According to another embodiment of the present invention, the external light absorption portions are disposed in a stripe form, a matrix from, or a wave form.

According to another embodiment of the present invention, the optical sheet is a sheet for enhancing a contrast ratio.

According to another embodiment of the present invention, a lengthwise direction of the external light absorption portion may not be parallel to a side of the optical sheet 200, and a bias angle α greater than 0° exists therebetween. Herein, when the external light absorption portion is formed in a straight linear stripe from, the “lengthwise direction” refers to a lengthwise direction of the straight linear strip; when the external light absorption portion is formed in a matrix form, the “lengthwise direction” refers to a straight line direction formed by connecting corresponding sites of matrix forming elements; and when the external light absorption portion is formed in a wave form, the “lengthwise direction” refers to a straight line direction formed by connecting corresponding sites of wave periods.

According to another aspect of the present invention, there is provided a filter for an image display device, wherein the filter includes: the optical sheet according to any one of the embodiments described above; and a filter base.

According to an embodiment of the present invention, the filter base includes a reflection prevention film, a hard coating layer, an electromagnetic wave shielding film, or a combination thereof.

According to another embodiment of the present invention, the filter for an image display device further includes a color adjustment film on an image light source side of the optical sheet.

According to another aspect of the present invention, there is provided an image display device comprising the optical sheet according to any one of the embodiments described above or a filter for an image display device.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective schematic view of an image display device equipped with a filter including an optical sheet, according to an embodiment of the present invention;

FIG. 2A is an exploded cross-sectional view of a filter including an optical sheet according to an embodiment of the present invention;

FIG. 2B is an exploded cross-sectional view of a filter including an optical sheet according to another embodiment of the present invention;

FIG. 3 is a partially enlarged view of the optical sheet of FIG. 2A before the optical sheet is mounted on the filter;

FIG. 4 is an enlarged view of a portion A of the optical sheet of FIG. 3, according to an embodiment of the present invention;

FIG. 5 is a cross-sectional view of an optical sheet according to another embodiment of the present invention, corresponding to the optical sheet of FIG. 3;

FIG. 6 is an enlarged view of a portion B of the optical sheet of FIG. 5, according to an embodiment of the present invention; and

FIG. 7 is a partially exploded perspective view of a modified example of the optical sheet of FIG. 3, which is designed for preventing the Moire phenomenon, according to an embodiment of the present invention.

### DETAILED DESCRIPTION OF THE INVENTION

The present invention will now be described more fully with reference to the accompanying drawings, in which exemplary embodiments of the invention are shown.

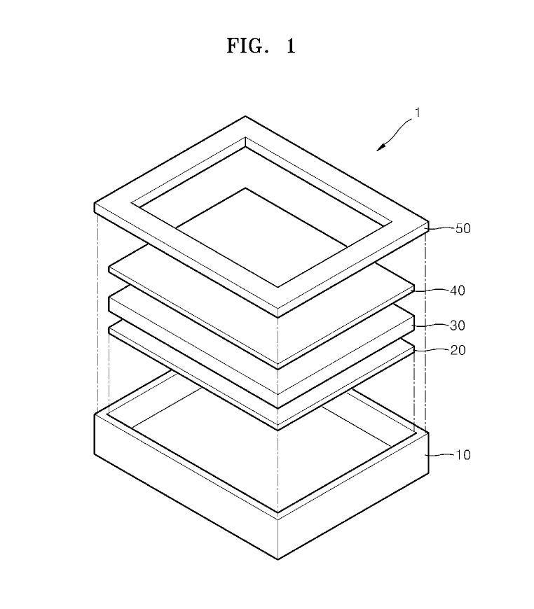

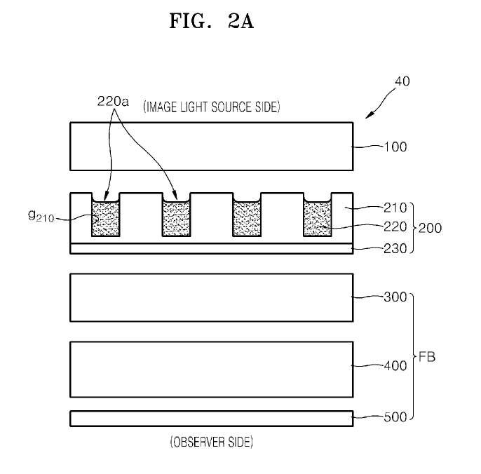

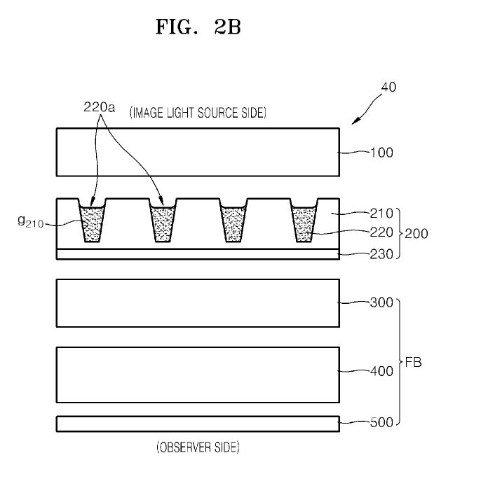

FIG. 1 is an exploded perspective view of an image display device 1 equipped with a filter 40 including an optical sheet, according to an embodiment of the present invention, FIG. 2A is an exploded cross-sectional view of the filter 40 including an optical sheet 200 according to an embodiment of the present invention, and FIG. 2B is an exploded cross-sectional view of the filter 40 including an optical sheet 200 according to another embodiment of the present invention;

Referring to FIG. 1, the display device 1 according to the current embodiment of the present invention includes a case 10, a cover 50 covering a top portion of the case 10, a driving circuit substrate 20 accommodated in the case 10, a panel assembly 30 that forms images, and the filter 40.

Visible images formed in the panel assembly 30 using an electrical signal applied from the driving circuit substrate 20 are displayed to the outside via the filter 40.

Referring to FIGS. 2A and 2B, each of the filters 40 according to embodiments of the present invention includes a color adjustment film 100, the optical sheet 200, and a filter base (FB) including an electromagnetic wave shielding film 300, a hard coating layer 400, and a reflection prevention film 500.

The color adjustment film 100 may include, for example, a neon light blocking colorant, and may further include a near-infrared ray absorption compound or a colorant.

The neon light blocking colorant included in the color adjustment film 100 may be a cyanine-based compound, a squarylium-based compound, an azomethine-based compound, a xanthene-based compound, an oxonol-based compound, or an azo-based compound. Herein, neon light refers to unnecessary light having a wavelength of about 585 nm generated as a neon gas is excited.

The near-infrared ray absorption compound may be a copper atom-containing resin, a copper compound or phosphorous compound-containing resin, a copper compound or thiourea derivative-containing resin, or a tungsten-based compound-containing resin. Near-infrared rays cause malfunction of surrounding electronic devices, and thus the near-infrared rays need to be blocked.

The optical sheet 200 includes a base film 230, a light transmission portion 210, and a plurality of external light absorption portions 220. The optical sheet 200 is disposed under the color adjustment film 100. The optical sheet 200 described above may be, for example, a sheet for enhancing a contrast ratio, but is not limited thereto. Here, the high-resolution sheet is interpreted in a broad sense, as a sheet used for increasing resolution of an image display device.

The light transmission portion 210 transmits light emitted from the panel assembly 30 illustrated in FIG. 1. The light transmission portion 210 may be formed of a curable resin. In particular, the light transmission portion 210 may be formed of an acrylate resin that can be cured when exposed to ionizing radiation or heat energy.

In addition, the light transmission portion 210 may be transparent, but not necessarily completely transparent, and may have a level of transparency that is generally acceptable in the art as being transparent. In general, the shape of the light transmission portion 210 may be complementary to the shape of the external light absorption portions 220, which will be described later, but the shape of the light transmission portion 210 is not limited thereto. That is, the light transmission portion 210 may have a plurality of grooves g₂₁₀ disposed at predetermined intervals, and the grooves g₂₁₀ are filled with a composition including a light absorbable material to form the external light absorption portions 220 which will be described later. A refractive index n₂₁₀ of the light transmission portion 210 may be in a range of 1.33 to 1.6. It is difficult to manufacture the light transmission portion 210 to have a refractive index n₂₁₀ of less than 1.33. On the other hand, when the refractive index n₂₁₀ of the light transmission portion 210 is greater than 1.6, the transmittance of the light transmission portion 210 is significantly decreased and the contrast ratio is also decreased, resulting in a decrease in the overall resolution.

According to the current embodiment, at least one of grooves g₂₁₀ of the light transmission portion 210 of the optical sheet 200 is incompletely filled with a composition including a light absorbable material and a portion of the groove g₂₁₀ is empty, which is called a recess portion 220a. However, the structure of the groove g₂₁₀ is not limited thereto. The recess portion 220a can be formed using various methods. For example, the recess portion 220a can be formed by compressing the composition including the light absorbable material with an elastic wiping blade when the groove g₂₁₀ is filled with the composition. Alternatively, the recess portion 220a can be formed by completely filling the groove g₂₁₀ with the composition and then compressing the filled composition by, for example, wiping. Alternatively, the recess portion 220a can be formed by filling the groove g₂₁₀ with a composition including a resin that can be contracted when cured or dried and then performing a curing or drying process. Specifically, as illustrated in FIGS. 2A and 2B, the recess portions 220a are formed on the top of the external light absorption portions 220 inside the groove g₂₁₀, and are defined by the external light absorption portions 220 and the light transmission portion 210 disposed on one side, and has a shape that its one side is open. Due to formation of the recess portions 220a, the optical sheet 200 can improve a light transmission rate while preventing a decrease in an external light absorption rate, which will be described in detail later.

The external light absorption portions 220 are formed by filling said each groove g₂₁₀ disposed in the light transmission portion 210 with a composition including a light absorbable material and at least one of a thermoplastic resin, a thermosetting resin and a ultra-violet light curable resin, to absorb external surrounding light and enhance a contrast ratio in a bright environment to retain high resolution. Referring to FIG. 2A, each of the external light absorption portions 220 has a tetragonal-shaped cross section, and referring to FIG. 2B, each of the external light absorption portions 220 has a trapezoidal-shaped cross-section.

The thermosetting resin or ultra-violet light curable resin that may be included in the external light absorption portions 220 may be identical to or different from a material for forming the light transmission portion 210.

Examples of the light absorbable material may include a black inorganic material, a black organic material, a black-oxidized metal, and a mixture thereof. The black-oxidized metal has a low electrical resistance. Thus, when the external light absorption portions 220 includes the black-oxidized metal, the external light absorption portions 220 can shield electromagnetic waves. The external light absorption portions 220 may be formed of a carbon-containing ultra violet light curable resin. The refractive index n₂₂₀ of the external light absorption portions 220 may be similar to the refractive index n₂₂₀ of the light transmission portion 210, specifically in a range of 1.33 to 1.6.

The base film 230 is disposed on one surface of the light transmission portion 210, that is, the surface opposite to that in which the recess portions 220a are formed. The base film 230 supports the light transmission portion 210 in which the external light absorption portions 220 are formed. The base film 230 may be formed of at least one material selected from the group consisting of polyethersulphone (PES), polyacrylate (PAR), polyetherimide (PEI), polyethylene naphthalate (PEN), polyethyleneterephthalate (PET), polyphenylene sulfide (PPS), polyallylate, polyimide, polycarbonate (PC), cellulose triacetate (TAC), and cellulose acetate propionate (CAP). Preferably, the base film 230 may be formed of polycarbonate (PC), polyethyleneterephthalate (PET), cellulose triacetate (TAC), or polyethylene naphthalate (PEN). In addition, a material for forming the base film 230 may have a refractive index equal or similar to the refractive index n₂₁₀ of the light transmission portion 210.

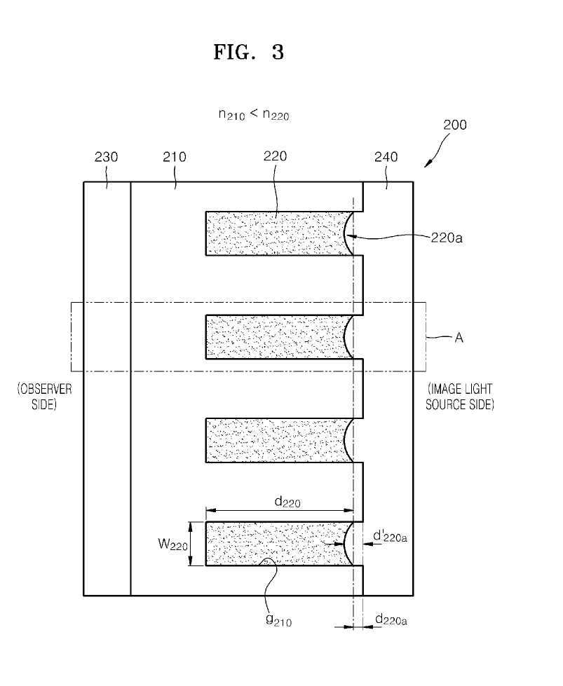

In addition, the optical sheet 200 according to the current embodiment of the present invention may further include a protection film 240 (see FIGS. 3 through 5) that will be described later, formed on one surface of the light transmission portion 210, that is, the surface opposite to that on which the base film 230 is formed. The protection film 240 protects the optical sheet 200 until the optical sheet 200 is mounted on the filter 40, and when the optical sheet 200 is mounted on the filter 40, the protection film 240 is separated from the optical sheet 200; however, the present invention is not limited thereto.

Meanwhile, after the optical sheet 200 is incorporated into the filter 40, the recess portions 220a may be completely filled with a part of an adhesive layer and/or the color adjustment film 100, but the present invention is not limited thereto. When the recess portions 220a are filled with a part of an adhesive layer, the material for forming the adhesive layer may have a refractive index equal or similar to the refractive index n₂₁₀ of the light transmission portion 210.

Referring to FIGS. 2A and 2B, the filter base (FB) is disposed on one side of the optical sheet 200, and includes an electromagnetic wave shielding film 300, a hard coating layer 400, and a reflection prevention film 500 disposed in this order. However, the structure of the FB is not limited thereto. That is, the shielding film 300, the hard coating layer 400, and the reflection prevention film 500 may be disposed in any order in the FB. The FB can also include a layer formed of at least two types of materials having different functions.

The electromagnetic wave shielding film 300 shields electromagnetic waves. The electromagnetic wave shielding film 300 may include a conductive mesh layer, a metal thin film, a high-refractive-index transparent thin film, or at least two layers thereof. In FIGS. 2A and 2B, the electromagnetic wave shielding film 300 is a single layer. However, the structure of the electromagnetic wave shielding film 300 is not limited thereto. For example, the electromagnetic wave shielding film 300 have a multi-layer structure including at least two layers.

The hard coating layer 400 is resistant to scratching and prevents the electromagnetic wave shielding film 300 or the reflection prevention film 500 that will be described later from being damaged by, for example, contact with external materials The hard coating layer 400 may be formed of reinforced glass alone, or reinforced glass including polymer as a binder. In addition, the hard coating layer 400 may include an acryl-based polymer, a urethane-based polymer, an epoxy-based polymer, a siloxane-based polymer, or an ultraviolet curable resin such as oligomer. Furthermore, the hard coating layer 400 may further include a silica-based filler to increase the hardness thereof.

The reflection prevention film 500 adjusts the level of transmittance of visible light so as to minimize eye fatigue of users viewing the image display device 1 for a long period of time. By using the reflection prevention film 500 to adjust the transmittance of visible light, visible light can be selectively absorbed and also, a color reproduction range such as a contrast ratio can be widened. In FIGS. 2A and 2B, the reflection prevention film 500 is a single layer. However, the structure of the reflection prevention film 500 is not limited thereto. For example, the reflection prevention film 500 can have a multi-layer structure including at least two layers.

The reflection prevention film 500 has a reflection prevention effect because visible light that enters from the outside and is reflected from the surface of the reflection prevention film 500 and visible light reflected from an interface between the reflection prevention film 500 and the hard coating layer 400 are out of phase with each other and destructive interference occurs.

The reflection prevention film 500 may be formed by curing and fixing a mixture of indium tin oxide (ITO) and silicon oxide (SiO₃), a mixture of nickel chromate (NiCr) and silicon oxide (SiO₂), or the like. In addition, the reflection prevention film 500 may be formed of titanium oxide or a specific fluorine resin having a low refractive index.

Hereinafter, particular configuration and operation effects of the light transmission portion 210, the external light absorption portion 220 and the recess portion 220a will be described more fully with reference to the accompanying drawings.

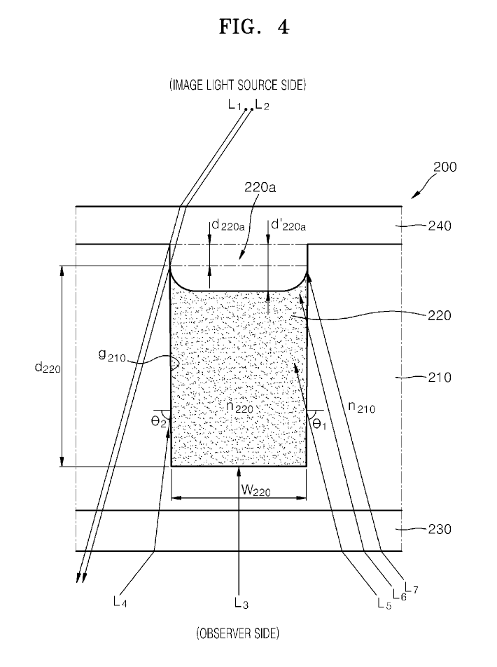

FIG. 3 is a partially enlarged view of the optical sheet 200 of FIG. 2A before the optical sheet 200 is mounted on the filter 40, and FIG. 4 is an enlarged view of a portion A of FIG. 3, according to an embodiment of the present invention. It should be noted that the protective film 240 is not removed.

In FIGS. 1 through 7, like reference numerals denote like elements.

The external light absorption portions 220 may be formed by performing a roll molding process, a thermal pressing process using a thermoplastic resin, or an injection molding process by which the grooves g₂₁₀ of the light transmission portion 210 having a shape opposite to the pattern of the external light absorption portions 220 are filled with a composition including a thermoplastic or thermosetting resin. In addition, when the ultra violet curable resin included in the light transmission portion 210 has a reflection prevention function, an electromagnetic wave shielding function, a color adjustment function, or a combined function thereof, the optical sheet 200 can additionally perform these functions.

Referring to FIGS. 3 and 4, the optical sheet 200 according to the current embodiment of the present invention includes the light transmission portion 210, the external light absorption portions 220, the base film 230, and the protection film 240. Herein, the protection film 240 may be optionally omitted.

The configuration of the light transmission portion 210, the external light absorption portion 220, the base film 230, and the protection film 240 is the same as described above.

The external light absorption portions 220 may be disposed in various forms, such as a stripe form, a matrix form, a wave form, or the like. In addition, the external light absorption portions 220 may be disposed at predetermined intervals to allow light to pass through between adjacent external light absorption portions 220. In FIG. 3, the external light absorption portions 220 have tetragonal-shaped cross sections. However, the cross-sectional shape of the external light absorption portions 220 is not limited thereto. For example, the external light absorption portions 220 may have triangular, trapezoidal, or pentagonal-shaped cross sections.

As described with reference to FIGS. 2A and 2B, each of the external light absorption portions 220 and the corresponding recess portions 220a are sequentially formed in the corresponding grooves g₂₁₀ of the light transmission portion 210. That is, the major portion of each groove g₂₁₀ is filled with a composition including a light absorbable material to form the external light absorption portion 220 and the other portion of the groove g₂₁₀ forms the recess portion 220a. The widthwise cross-section of the recess portion 220a is U-shaped, but the shape of the recess portion 220a is not limited thereto. When the optical sheet 200 is combined with the color adjustment film 100 to form the filter 40, the recess portion 220a is filled with a part of an adhesive layer (not shown) having a refractive index equal or similar to the refractive index n₂₁₀ of the light transmission portion 210.

In the present embodiment, the depth of the recess portion 220a, specifically, the maximum depth d₂₂₀ₐ of the interface between the recess portion 220 and the light transmission portion 210 is considered an important factor. This is because the depth d₂₂₀ₐ has a greater effect on a light transmission rate than the depth of the other portion of the recess portion 220. Such phenomenon will now be exemplarily described with reference to FIG. 4 using light L₁ and L₂ that are incident on the optical sheet 200 from the image light source side. Herein, light L₁ refers to a rightmost light ray that is emitted from an image light source and then is incident on the part of the light transmission portion 210 disposed on the left of the external light absorption portion 220 in FIG. 4 when the recess portion 220a is not formed(i.e., the conventional technique), and light L₂ refers to a rightmost light ray that is emitted from the image light source and is incident on the part of the light transmission portion 210 disposed on the left of the external light absorption portion 220 in FIG. 4 when the recess portion 220a is formed(i.e., the present invention). When the recess portion 220a is formed, lights corresponding to lights passing between optical paths of light L₁ and light L₂ can be additionally incident on the light transmission portion 210, and thus, the light transmission rate of the optical sheet 200 can be increased and brightness of the image display device 1 having the optical sheet 200 can be increased. In addition, as described above, the grooves g₂₁₀ are formed in the light transmission portion 210 and only a portion of each groove g₂₁₀ is filled with a composition including a light absorbable material to form the external light absorption portion 220, and thus, the filling process with a composition including a light absorbable material can be easily performed and the manufacturing costs can be lower than those of conventional techniques. Furthermore, residue of the composition on the light transmission portion 210 surrounding the grooves g₂₁₀, which is a problem in the conventional art, may not be formed.

A ratio of the maximum depth d₂₂₀ₐ of the interface between the recess portion 220 and the light transmission portion 210 to a width W₂₂₀ of the external light absorption portion 220 may be in a range of 1/400 to 1/1. Specifically, the maximum depth d₂₂₀ₐ of the interface between the recess portion 220 and the light transmission portion 210 may be in a range of 0.1 to 10 μm when the width W₂₂₀ of the external light absorption portion 220 is in a range of 10 to 40 μm. If the ratio of the depth d₂₂₀ₐ to the width W₂₂₀ is less than 1/400, the light transmission rate improvement effect may be negligible. On the other hand, if the ratio of the depth d₂₂₀ₐ to the width W₂₂₀ is greater than 1/1, an external light absorption rate may be reduced.

Referring to FIG. 4, a ratio of the maximum depth d′₂₂₀ₐ of the recess portion 220a to the width W₂₂₀ of the external light absorption portion 220 may be in a range of 1/400 to 2/1. Specifically, the maximum depth d′₂₂₀ₐ of the recess portion 220a may be in a range of 0.1 to 20 μm when the width W₂₂₀ of the external light absorption portion 220 is in a range of 10 to 40 μm.

If the ratio of the maximum depth d′₂₂₀ₐ of the recess portion 220a to the width W₂₂₀ of the external light absorption portion 220 is less than 1/400, it is difficult to form a recess portion. On the other hand, if the ratio of the maximum depth d′₂₂₀ₐ of the recess portion 220a to the width W₂₂₀ of the external light absorption portion 220 is greater than 2/1, the external light absorption rate may be decreased.

Herein, the width W220 of the external light absorption portion 220 is a width of an end portion of the external light absorption portion 220 on the image light source side. For example, when the cross section of the external light absorption portion 220 is trapezoidal-shaped as illustrated in FIG. 2B, the width W₂₂₀ of the external light absorption portion 220 is a width of an end portion of the external light absorption portion 220 on the image light source side, that is, the largest width of the external light absorption portion 220.

A ratio of the maximum depth d₂₂₀ₐ of the interface between the recess portion 220 and the light transmission portion 210 to a depth d₂₂₀ of the external light absorption portion 220 may be in a range of 1/2000 to 1/5. Specifically, the maximum depth d₂₂₀ₐ of the interface between the recess portion 220 and the light transmission portion 210 may be in a range of 0.1 to 10 μm when the depth d₂₂₀ of the external light absorption portion 220 may be in a range of 50 to 200 μm. If the ratio of the maximum depth d₂₂₀ₐ of the interface between the recess portion 220 and the light transmission portion 210 to the depth d₂₂₀ of the external light absorption portion 220 is less than 1/2000, the light transmission rate improvement effect may be negligible. On the other hand, if the ratio of the maximum depth d₂₂₀ₐ of the interface between the recess portion 220 and the light transmission portion 210 to the depth d₂₂₀ of the external light absorption portion 220 is greater than 1/5, the external light absorption rate may be decreased.

A ratio of the maximum depth d′₂₂₀ₐ of the recess portion 220a to the depth d₂₂₀ of the external light absorption portion 220 may be in a range of 1/2000 to 2/5. Specifically, the maximum depth d′₂₂₀ₐ of the recess portion 220a may be in a range of 0.1 to 20 μm when the depth d₂₂₀ of the external light absorption portion 220 is in a range of 50 to 200 μm.

If the ratio of the maximum depth d′₂₂₀ₐ of the recess portion 220a to the depth d₂₂₀ of the external light absorption portion 220 is less than 1/2000, it is difficult to form a recess portion. On the other hand, if the ratio of the maximum depth d′₂₂₀ₐ of the recess portion 220a to the depth d₂₂₀ of the external light absorption portion 220 is greater than 2/5, the external light absorption rate may be decreased.

The optical sheet 200 according to the current embodiment of the present invention may further include a prism portion (not shown) disposed on one surface of the base film 230, that is, the surface opposite to that on which the light transmission portion 210 is disposed. A material for forming the prism portion may be identical or similar to the material for forming the light transmission portion 210. By including the prism portion, the optical sheet 200 can have a high external light absorption rate, an enhanced contrast ratio, and a high resolution, without a large change in transmittance.

In the current embodiment, the refractive index n₂₂₀ of the external light absorption portions 220 may be adjusted to be higher than the refractive index n₂₁₀ of the light transmission portion 210 (that is, n₂₁₀<n₂₂₀).

Specifically, −0.05≦Δn<0 where Δn=n₂₁₀-n₂₂₀. Thus, the external light absorption rate of the optical sheet 200 can be increased, resulting in a reduction in formation of ghost images, which will be described in detail later. Herein, a ghost image refers to an overlapped image of the same image realized to a user viewing an image display device.

A principle of reducing or eliminating ghost images by adjusting the refractive index difference between the external light absorption portions 220 and the light transmission portion 210 will now be described more fully with reference to FIG. 4. Referring to FIG. 4, when external surrounding lights L₃, L₄ and L₅ are incident on the external light absorption portion 220, the lights L₃, L₄ and L₅ are completely absorbed by the external light absorption portion 220 without being reflected from the interface between the light transmission portion 210 and the external light absorption portion 220, due to the adjusted refractive index difference, regardless of an incidence angle, that is, angles (0°, θ1, η2) between the lights L₃, L₄, L₅ and the normal of the interface between the light transmission portion 210 and the external light absorption portion 220. Thus, the external light absorption rate is increased, and thus, the generation of ghost images is reduced.

Meanwhile, unlike the current embodiment, the refractive index difference (Δn=n₂₁₀-n₂₂₀) between the light transmission portion 210 and the external light absorption portion 220 can have a positive value. In this case, an image light that is incident on the interface between the light transmission portion 210 and the external light absorption portion 220 at an angle less than a critical angle is totally reflected to an observer side, thereby forming an image different from an image which has been formed in the panel assembly 30, that is, a ghost image.

Hereinafter, a change in an external light absorption rate of the external light absorption portion 220 due to formation of the recess portion 220a will now be described in detail.

Referring to FIG. 4, external lights L₃ and L₄ are incident on a portion of the external light absorption portion 220 on an observer side and are absorbed thereon. That is, of the external surrounding light, the percentage of lights, such as lights L₅, L₆, and L₇, that is incident on a portion of the external light absorption portion 220 on the image light source side is relatively low, and the incident light is also absorbed on the portion of the external light absorption portion 220 on the image light source side. Therefore, formation of the recess portion 220a does not significantly affect the external light absorption rate of the external light absorption portion 220.

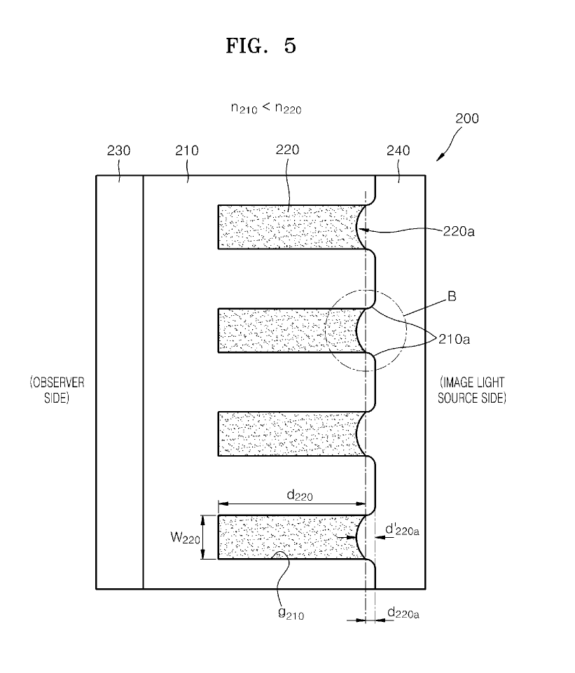

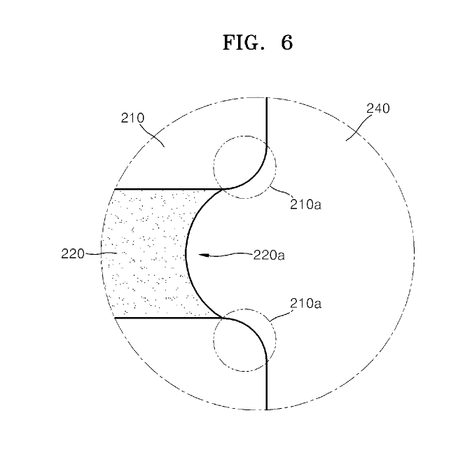

FIG. 5 is a cross-sectional view of an optical sheet 200 according to another embodiment of the present invention, the view corresponding to the optical sheet 200 of FIG. 3, and FIG. 6 is an enlarged view of a portion B of FIG. 5.

The current embodiment is different from the previous embodiment described with reference to FIG. 3, in that an end portion of the light transmission portion 210 on the image light source side, which contacts an end portion of the external light absorption portion 220 on the image light source side, includes a convex portion 210a. Referring to FIGS. 5 and 6, the convex portion 210a partially defines the recess portion 220a. Due to the convex portion 210a, some lights that is emitted from the image light source side and is incident on the convex portion 210a can be collected at the convex portion 210a and transmitted to the observer side through the light transmission portion 210. Therefore, a light transmission rate of the optical sheet 200 or the filter 40 can be further improved and brightness and the light transmission rate of an image display device including the optical sheet 200 or the filter 40 can be further improved.

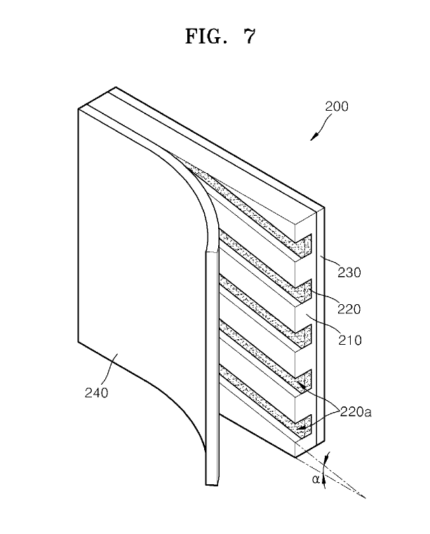

FIG. 7 is a partially exploded perspective view of a modified example of the optical sheet 200 of FIG. 3, which is designed to prevent the Moire phenomenon, according to an embodiment of the present invention. The Moire phenomenon refers to a phenomenon by which an interference fringe is formed when at least two periodic patterns overlap each other.

Referring to FIG. 7, a lengthwise direction of the external light absorption portion 220 is not parallel to a side of the optical sheet 200, and a bias angle a greater than 0° exists therebetween. Although not illustrated in FIG. 7, a panel assembly, corresponding to the panel assembly 30 of FIG. 1, includes a plurality of cells that emit visible light, thereby forming images. The cells may be disposed in a stripe form, matrix form, or wave form, and thus are disposed similarly to the external light absorption portions 220 of the optical sheet 200. When the external light absorption portions 220 and the cells have the same disposition orientation, both patterns overlap each other, and thus the Moire phenomenon occurs. By adjusting the bias angle a between the lengthwise direction of the external light absorption portion 220 and a longitudinal side of the light transmission portion 210 to be greater than 0°, both patterns do not coincide with each other when observed by users, thereby preventing the Moire phenomenon. Preferably, the bias angle a may be in a range of 5 to 80°.

The optical sheet or filter described above can be used to form an image display device. The image display device including the optical sheet or the filter has high brightness, high contrast ratio, and high resolution, while formation of ghost images and occurrence of the Moiré phenomenon are prevented.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An optical sheet comprising:
a light transmission portion comprising a plurality of grooves disposed at predetermined intervals in an end portion of the light transmission portion on one side; and
a plurality of external light absorption portions each disposed in said each groove and comprising a composition completely or incompletely filling said each groove, the composition comprising a light absorbable material,
wherein at least one of the grooves comprises a recess portion formed on the top of the external light absorption portion.

2. The optical sheet of claim 1, wherein a ratio of a maximum depth of a interface between the recess portion and the light transmission portion to a width of the corresponding external light absorption portion is in a range of 1/400 to 1/1.

3. The optical sheet of claim 2, wherein a width of the external light absorption portion is in a range of 10 to 40 μm and the maximum depth of the interface between the recess portion and the light transmission portion is in a range of 0.1 to 10 μm.

4. The optical sheet of claim 1, wherein a ratio of a maximum depth of the recess portion to a width of the corresponding external light absorption portion is in a range of 1/400 to 2/1.

5. The optical sheet of claim 4, wherein the width of the external light absorption portion is in a range of 10 to 40 μm, and the maximum depth of the recess portion is in a range of 0.1 to 20 μm.

6. The optical sheet of claim 1, wherein a ratio of a maximum depth of a interface between the recess portion and the light transmission portion to a depth of the corresponding external light absorption portion is in a range of 1/2000 to 1/5.

7. The optical sheet of claim 6, wherein the depth of the external light absorption portion is in a range of 50 to 200 μm and the maximum depth of the interface between the recess portion and the light transmission portion is in a range of 0.1 to 10 μm.

8. The optical sheet of claim 1, wherein a ratio of a maximum depth of the recess portion to a depth of the corresponding external light absorption portion is in a range of 1/2000 to 2/5.

9. The optical sheet of claim 8, wherein the depth of the external light absorption portion is in a range of 50 to 200 μm, and the maximum depth of the recess portion is in a range of 0.1 to 20 μm.

10. The optical sheet of claim 1, wherein an end portion of the light transmission portion on an image light source side that contacts an end portion of the external light absorption portion on the image light source side comprises a convex portion, wherein the convex portion partially defines the recess portion.

11. The optical sheet of claim 1, wherein a refractive index of the light transmission portion is less than a refractive index of the external light absorption portions.

12. The optical sheet of claim 1, wherein each of the external light absorption portions has a triangular, trapezoidal, or pentagonal-shaped cross section.

13. The optical sheet of claim 1, wherein the external light absorption portions are disposed in a stripe form, a matrix from, or a wave form.

14. The optical sheet of claim 1, wherein a lengthwise direction of the external light absorption portions is not parallel with one surface of the optical sheet.

15. The optical sheet of claim 1, wherein the optical sheet is a sheet for enhancing a contrast ratio.

16. A filter for an image display device, the filter comprising:
an optical sheet comprising claim 1;
a light transmission portion including a plurality of grooves disposed at predetermined intervals in an end portion of the light transmission portion on one side;
a plurality of external light absorption portions each disposed in said each groove and comprising a composition completely or incompletely filling said each groove, the composition comprising a light absorbable material,
wherein at least one of the grooves comprises a recess portion formed on the top of the external light absorption portion; and
a filter base.

17. An image display device comprising an optical sheet having a light transmission portion including a plurality of grooves disposed at predetermined intervals in an end portion of the light transmission portion on one side; and
a plurality of external light absorption portions each disposed in said each groove and comprising a composition completely or incompletely filling said each groove, the composition comprising a light absorbable material,
wherein at least one of the grooves comprises a recess portion formed on the top of the external light absorption portion.
